(19) United States
(12) Patent Application Publication
(10) Pub. No.: US 2014/0353368 A1
(43) Pub. Date: Dec. 4, 2014

(54) MULTI-BAND RECONFIGURABLE ELECTRONIC SHELF LABEL SYSTEM

(71) Applicant: Symbol Technologies, Inc., Schaumburg, IL (US)

(72) Inventors: Sean Connolly, Stony Brook, NY (US); Mark Duron, East Patchogue, NY (US); Jay Greenrose, Manorville, NY (US); Bert Scaramozzino, Remsenburg, NY (US)

(21) Appl. No.: 13/903,053

(22) Filed: May 28, 2013

(51) Int. Cl. G09G 5/22

(52) U.S. Cl. CPC G09G 5/22
USPC 235/375

(57) ABSTRACT

Updating a multi-band reconfigurable electronic shelf label includes waking-up a transceiver and processor of the electronic shelf label, such that the transceiver can be reconfigured to operate on a selected frequency band in order to receive updated information on a data link associated with that selected frequency band. The selected frequency band is chosen based on a power efficiency of the associated data link. The updated information can be received on the associated data link of the selected frequency band, and can be displayed on a display of the electronic shelf label. A supplemental data link using a Radio Frequency Identification circuit can be provided among the other data link selections in the label.

### BACKGROUND

Electronic shelf labels (ESL) are now being used to provide information on products being displayed in a retail establishment. Typically, electronic display modules are attached to the front edge of a shelf holding the product, similar to the manual printed shelf labels that are widely deployed today. A system employing ESL may include one or more electronic display modules, such as Liquid Crystal Display (LCD) or similar technology, which can be used to display pricing and other information about associated products. The ESL module typically includes one or more wireless radios with a power source, for example a battery. Each radio is configured to communicate with access points within range using radio frequency (RF) signals.

Information, such as pricing information, sent from the host system to one or more electronic shelf labels using access points may be obtained from a server in communication with the access points. This enables the ESL system to automatically update displayed prices or other information in less time than it takes to update manual printed shelf labels. Due to the potential numbers of these electronic labels, the number of devices attempting to update their display information can lead to interference and multiple re-tries of the display data that could impact battery life of the ESL. There can also be significant amounts of ambient interference due to other wireless systems within the communication range of these labels.

One method for updating the label information is for each electronic label to periodically wake up its processor and radio(s) and listen for an update message from a server access point. This approach works, but implies latency in the update radio link and wasted battery life due to waking up frequently to listen for no reason if there is no update message. In addition, there are no known automated systems for verifying that the information displayed on electronic shelf labels is correct for the associated merchandize on the display shelf.

Accordingly, there is a need for a technique to allow for multiple redundant methods of updating electronic shelf label display information and acknowledging the receipt of the display data. It would also be of benefit if the technique could adapt to the most reliable update technique while minimizing the use of battery power.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system used in accordance with some embodiments of the present invention.

FIG. 2 is a side view of a retail application of the system of FIG. 1.

FIG. 3 is a flow diagram of a method in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides a technique to allow for multiple redundant methods of updating electronic shelf label (ESL) display information and acknowledging the receipt of the display data. Since incorrect signage/pricing in a retail store not only results in lost sales but can be a penalty from local governments, a robust, redundant update approach is necessary. The present invention uses a hierarchal scheme of acquiring display data over multiple physical layers and adapting to the most reliable method while minimizing battery power. In particular, the present invention a display update approach that utilizes the lowest power radio approach as a primary update mechanism, and uses alternative radios in the electronic label system as a redundant display update technique in the event of high interference.

In addition, a radio of the ESL can be re-configured to run a periodic Radio Frequency Identification (RFID) monitor or sniffer to detect local tag backscatter with the purpose of associating RFID tagged inventory with the location of the Electronic Label. This will not only validate the location of the Electronic label relative to the merchandise it is placed near, but will also be able to pass along (over an alternate data link) tag reads to the host system as a supplementary “remote” RFID reader system which can increase the percentage of tags read by an RFID reader network.

The present invention utilizes a RFID Battery Assisted Passive Tag function that enables a very low power method for triggering modes of operation of the ESL over an RFID inventory system. This eliminates the need for continuously waking up from low power modes to listen for radio communications. Once triggered, the ESL can use the data link that will maximize the battery efficiency of the operation based on: interference, last known good link, and remaining battery life.

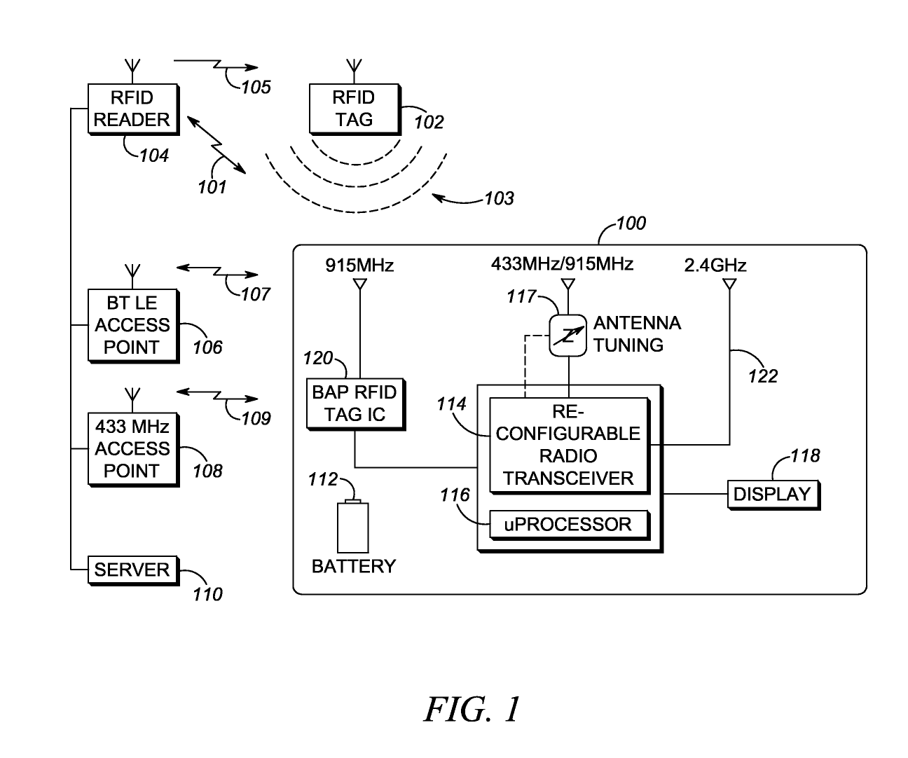

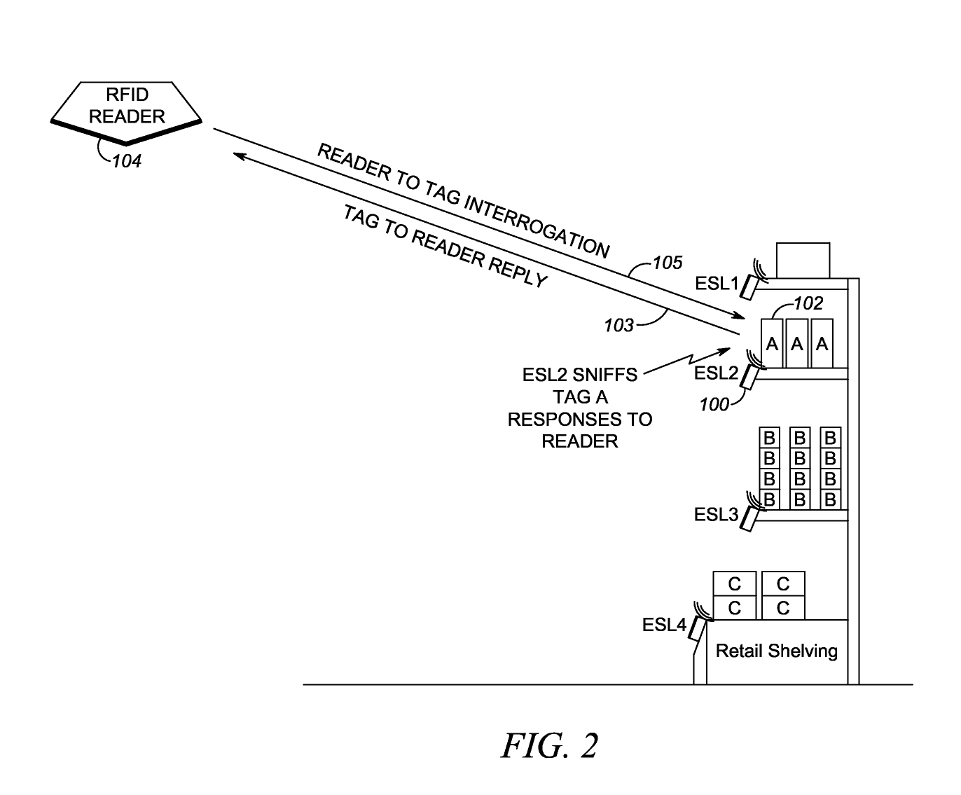

FIG. 1 is a block diagram of a multi-band reconfigurable electronic shelf label system used in accordance with some embodiments of the present invention. An electronic shelf label (ESL) 100 is powered by a power source, such as a battery 112, and includes a radio transceiver 114 under control of a processor 116 that includes a memory. The ESL may be affixed to display objects, such as shelves or racks, to provide information on a display 118, such as pricing, about the products that are positioned on the shelves or racks in proximity to the ESL. For example, in FIG. 2, electronic shelf label ESL2 is affixed on a shelf used to display associated products A. The display component can be an E-Paper display, Liquid Crystal Display, or other technology under control of the processor. ESLs may also be affixed or attached to the products displayed on the shelves or racks.

Referring back to FIG. 1, the radio transceiver 114 can be configured to operate on different frequencies. For example, the ESL can include a Battery-Assisted Passive (BAP) Radio Frequency Identification (RFID) circuit 120 operable in a 915 MHz frequency band in order to communicate with an RFID reader 104 and/or RFID tags 102 using an RFID data link and RFID protocols. The radio transceiver can also be configured to operate on other frequency bands, such as a Bluetooth™2.4 GHz band 122. The radio transceiver could also be configured to switch between other frequency bands, such as the RFID band and a 433 MHz band using an antenna tuning element 117.

The ESL can communicate with one or more access points 106, 108 or RFID reader 104, using associated data links and communication protocols, in order to communicate with a system host server 110. For example, the processor can configure the transceiver to communicate with a Bluetooth™ Low Energy (BT LE) access point 106 using a separate antenna circuit 122 tuned to 2.4 GHz and using a Bluetooth™ data link and protocols. In addition, the processor can switch between data links/protocols such that the ESL can receive a downlink on one data link/protocol and send an uplink on a different data link/protocol. An access point 106, 108 or RFID reader 104 is configured to broadcast a waveform to an ESL, where the waveform is encoded with an address of the ESL and information to be shown on the ESL display. When the encoded waveform is decoded in an addressed ESL, the decoded information is used to update information shown on the ESL display. In addition to sending encoded waveforms to ESLs, each access point or RFID reader is configured to receive response signals from ESLs. The broadcast waveform and response can use different data links and protocols.

Response signals received from an ESL can include an identification of the ESL, an acknowledgement of instructions, and/or RFID information. The access points or RFID reader may then relay this response information to the host server 110. The access points and/or RFID reader can be wireless connected to the host server, via Wireless Fidelity (Wi-Fi), for example. Alternatively, the access points and/or RFID reader could be connected to host device via wired connections, such as Ethernet for example.

The ESL can be compliant to IEEE 802.11 protocols and variants thereof. Additionally, the ESL can utilize other wireless technologies such as, but are not limited to: RF; IrDA (infrared); Bluetooth; ZigBee (and other variants of the IEEE 802.15 protocol); IEEE 802.11 (any variation); IEEE 802.16 (WiMAX or any other variation); Universal Mobile Telecommunications System (UMTS); Code Division Multiple Access (CDMA) including all variants; Global System for Mobile Communications (GSM) and all variants; Time division multiple access (TDMA) and all variants; Direct Sequence Spread Spectrum; Frequency Hopping Spread Spectrum; wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB.

Referring back to FIG. 1, the ESL uses its multiband capability to choose the lowest power, most effective means of communication in order to save battery life. Typically, the RFID data link uses the lowest power, but suffers from a low range (up to fifty feet). The BT LE data link uses a higher power than the RFID data link, and has a medium range (up to one hundred feet), while also providing low latency. The 433 MHz data link uses even higher power, and has a long range (up to one thousand feet), but has a high latency. It should be recognized that the ESL needs to use only two of these frequency bands to utilize the present invention, but that more frequency bands could be used if the ESL has that capability. Each of these bands is subject to noise and interference. For example, the 2.4 GHz (BT) band is subject to other Bluetooth™ communications, such as barcode scanners, BT headsets, etc. The 902-928 MHz RFID band is subject to other communications besides RFID, such as certain cellular phones, cordless phones, cordless barcode scanners, etc. The 433 MHz band is also subject to other communications includes proprietary systems. As such, even though the present invention primarily selects its chosen communication data link based on power concerns, this must be weighted against noise, interference, the number of retries on that link, whether that data link was the last known good link, and other quality of service parameters. Therefore, even if the RFID link uses the least amount of power, this choice may be outweighed by too much interference on that link, wherein the ESL may choose the BT link to communicate, or may choose to use the RFID downlink while using the BT uplink. As can be seen, various combinations of data links could be used.

In general, the ESL processor is operable to reconfigure the ESL transceiver, and optionally antenna impedance matching, to operate on a particular frequency band in order to receive updated information on a data link associated with that particular frequency band to display on the electronic shelf label. The processor could tune the antenna according to the mode or frequency band in which it is operating, thereby allowing the re-use of a single antenna element. To save power, the transceiver can be powered down when not in use, and the processor can wake-up the transceiver and select the particular frequency band to receive the updated information to show on the ESL display. The processor can select among all the available data links to receive the updated information.

If the frequency band selection is strictly based on power efficiency, an associated supplemental data link of the RFID circuit will be chosen. Using this RFID link also has the advantage that the processor is also powered down when there are no communications. The RFID circuit will be woken (powered) up by any interrogation signal from an RFID reader, which in turn can be used to wake up the processor and transceiver. In contrast, if either of the BT or 433 MHz links are selected, due to other concerns besides power efficiency, the processor and transceiver must be powered up periodically to check for and receive any communications from the server. This requires synchronization and more power consumption, which is not needed when using the RFID link.

In one embodiment, the update information can be supplied by the server on more than one of the data links, wherein the processor is operable to first attempt to receive the updated information on the RFID supplemental data link, and if this is unsuccessful, the processor can attempt to retrieve the update information from the other data links. Once the update information is properly received, the processor can acknowledge proper receipt of the update using the same or a different data link than that used to receive the update. Alternatively, the processor can use the RFID circuit solely as a trigger to wake up the processor and transceiver, which are then used to receive the update information on a different data link, e.g. wake up the processor and transceiver to listen for advertising packets on the LE BT band to retrieve the update information. In this way, the present invention can use the RFID BAP tag function to enables a very low power method for triggering modes of operation of the ESL over an RFID inventory system. This eliminates the need for continuously waking up to listen for radio communications. Once triggered, the ESL processor will optimize the selection of the data link that will maximize the battery efficiency of the communication in consideration of quality of service parameters.

In a further embodiment, the processor is also operable to direct the transceiver to monitor (sniff) local tag backscatter responses from Radio Frequency Identification tags being interrogated by an external Radio Frequency Identification reader during normal interrogations. The monitoring or responses can be done periodically and can be based on scheduling instructions received by the processor through one of the Serial Peripheral Interface or General Purpose Interface of the RFID circuit or possibly through one of the data links. These scheduling instructions will decrease the time required to intercept a tag response. In particular, the processor is operable to synchronize the monitoring with a known schedule of RFID interrogations previously received from the server. Specifically, the processor can synchronize the receiving of updates from an RFID reader on the supplemental data link and receive the actual updates on one of the other data links.

Monitoring (sniffing) can serve two purposes. In one purpose, the processor can pass along (over an alternate data link) tag reads to the host server as a supplementary “remote” RFID reader, which could increase the percentage of tags read by the over-all RFID reader network. In another purpose, the processor can associate the electronic shelf label with identities encoded within the responses to confirm that it is associated with the correct merchandise to validate the location of the ESL relative to the merchandise it is placed near. This can be done on multiple channels or a single channel in the 915 MHz Band, and can be done periodically throughout the day in order to capture changes to the merchandise inventory.

In particular, referring back to FIG. 2, host server can verify the location of an ESL by comparing the known location(s) of merchandise associated with ESL. When the ESL 100 monitors RFID tags A proximate to itself, it will forward identities of these tags to the server. If there are multiple tag responses received from nearby tags, such as A and B, the processor correlates the ESL with an identity encoded within the response having the highest signal strength as its associated merchandise, i.e. the correct merchandise A is closer to ESL 100 than B and will give a stronger signal.

The server will recognize if the identities are of merchandise that should be at or close to the ESL. If so, the ESL is verified as being in the proper location. Upon verifying the location of the ESL, the server can also verify that the correct information is being displayed on the ESL. If the identities are of merchandise that is not associated with the ESL, the server can report to, for example a sales associate, about the problem and about where the identified merchandise is located for correction of the problem.

In a further embodiment, the processor is also operable to direct the transceiver to monitor a carrier from an external RFID reader, and lock onto the carrier in order to provide carrier drift/error compensation.

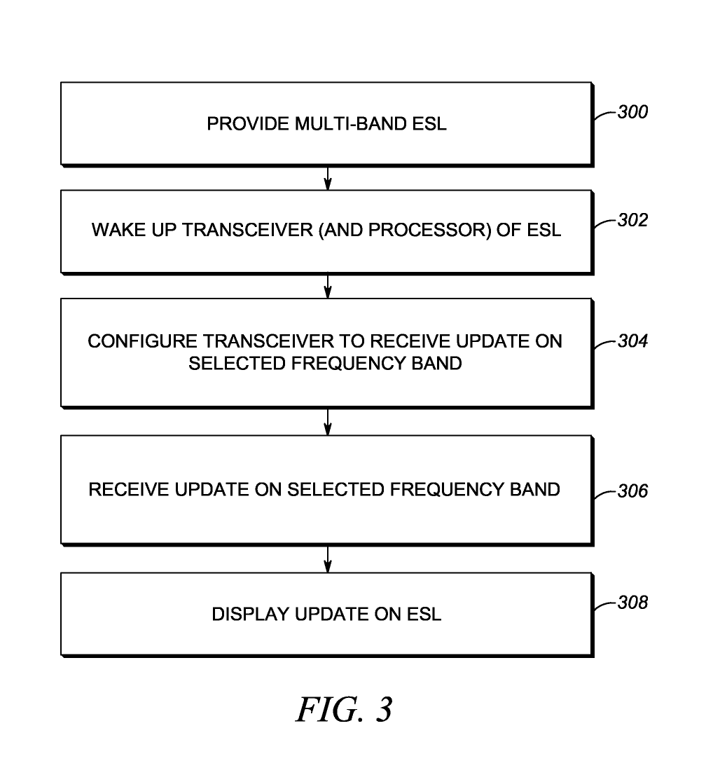

FIG. 3 is a flow diagram of a method for updating a multi-band reconfigurable electronic shelf label. The method includes a first step 300 of providing an electronic shelf label operable on multiple frequency bands. A next step 302 includes waking-up a transceiver (and processor if using an RFID interrogation signal to wake up the ESL) of the electronic shelf label. A next step 304 includes reconfiguring the transceiver to operate on a selected frequency band in order to receive updated information on a data link associated with that selected frequency band, wherein the selected frequency band is chosen based on an power efficiency of the associated data link. A next step 306 includes receiving the updated information on the associated data link of the selected frequency band. A next step 308 includes displaying the updated information on a display of the electronic shelf label.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for updating a multi-band reconfigurable electronic shelf label, the method comprising:
providing an electronic shelf label operable on multiple frequency bands;
waking-up a transceiver and processor of the electronic shelf label;
reconfiguring the transceiver to operate on a selected frequency band in order to receive updated information on a data link associated with that selected frequency band, wherein the selected frequency band is chosen based on a power efficiency of the associated data link;
receiving the updated information on the associated data link of the selected frequency band; and
displaying the updated information on a display of the electronic shelf label.

2. A multi-band reconfigurable electronic shelf label system, comprising:
a transceiver that is reconfigurable to operate on multiple frequency bands;
a processor being coupled to the transceiver, the processor operable to reconfigure the transceiver to operate on a particular frequency band in order to receive updated information on a data link associated with that particular frequency band to display on the electronic shelf label, the processor operable to wake-up the transceiver and select the particular frequency band to receive the updated information based on an power efficiency of the associated data link; and
a display coupled to the processor, the display operable to display the updated information obtained by the transceiver and processor.

3. The system of claim 2, further comprising a Radio Frequency Identification circuit coupled to the processor, the Radio Frequency Identification circuit operable to provide a supplemental data link for the electronic shelf label.

4. The system of claim 3, wherein the processor is operable to first attempt to receive the updated information on the supplemental data link.

5. The system of claim 3, wherein the Radio Frequency Identification circuit is operable to wake-up the transceiver and processor when the circuit detects an interrogation signal.

6. The system of claim 5, wherein after waking-up the processor is further operable to select among all the available data links to receive the updated information.

7. The system of claim 2, wherein the processor acknowledges the update using a data link different from the data link used to receive the update.

8. The system of claim 2, wherein the processor is also operable to direct the transceiver to monitor responses from Radio Frequency Identification tags being interrogated by an external Radio Frequency Identification reader, whereupon the processor can associate the electronic shelf label with identities encoded within the responses.

9. The system of claim 8, wherein the processor associates the electronic shelf label with an identity encoded within the response having the highest signal strength.

10. The system of claim 8, wherein the processor direct the transceiver to monitor responses based on scheduling instructions receive by the Radio Frequency Identification circuit.

11. The system of claim 8, wherein the processor is operable to synchronize the monitoring with a known schedule of Radio Frequency Identification interrogations.

12. The system of claim 8, wherein the processor is operable to synchronize the receiving of updates from the Radio Frequency Identification reader on the supplemental data link with updates from other data links.

13. The system of claim 2, wherein the processor is also operable to direct the transceiver to monitor a carrier from an external Radio Frequency Identification reader, and to lock onto the carrier to provide carrier drift/error compensation.

14. The system of claim 2, wherein the processor will choose the data link using the least battery power for updating the electronic shelf label.

15. The system of claim 2, wherein the processor will choose the data link for updating the electronic shelf label based primarily on the power efficiency of the data link and secondarily on interference on the data link.

16. The system of claim 2, wherein the processor will choose the data link for updating the electronic shelf label based primarily on the power efficiency of the data link and secondarily on whether that data link was the last known good link.
